(19) United States
(12) Patent Application Publication
(10) Pub. No.: US 2003/0121830 A1
(43) Pub. Date: Jul. 3, 2003

(54) Method for treating gasoline vapor and apparatus therefor

(76) Inventors: Kojiro Kuroyanagi, Obu-shi (JP); Takashi Nagai, Obu-shi (JP)

Correspondence Address: STEVENS, DAVIS, MILLER & MOSHER, L.L.P., Suite 850, 1615 L Street, N.W., Washington, DC, 20036, US

(21) Appl. No.: 10/325,972

(22) Filed: Dec. 23, 2002

(30) Foreign Application Priority Data
Dec. 27, 2001 (JP) 2001-396171

(51) Int. Cl. B01D 7/00; B01D 3/00

(52) U.S. Cl. 208/348; 208/350; 203/68; 202/152; 196/98

(57) ABSTRACT

A method and an apparatus for treating gasoline vapor by bringing gasoline vapor within a fuel tank into contact with a fluid gasoline and making the fluid gasoline absorb the gasoline vapor, in order to improve absorptivity of the gasoline vapor and to reduce the amount of the gasoline vapor introduced into a canister, thereby attaining a canister downsizing. The method and apparatus comprise a separation device of introducing the liquid gasoline within the fuel tank and separating it into a low boiling point component and a high boiling point component, and a gas-liquid contact device of bringing the gasoline vapor within the fuel tank into contact with an extractive gasoline composed of the high boiling point component separated by the separation device, whereby when contacting the gasoline vapor with the extractive gasoline, a part of the gasoline vapor is absorbed to the extractive gasoline, and a residual of the gasoline vapor not absorbed to the extractive gasoline is introduced into a canister.

### BACKGROUND OF THE INVENTION

1. Field of the Invention

The present invention relates to a method for treating gasoline vapor and an apparatus therefor.

2. Description of the Related Art

For preventing gasoline vapor generated from a fuel tank loaded on a motor vehicle from diffusing in the atmospheric air, there is conventionally known a method in which all of gasoline vapor generated during refueling is made to be adsorbed to a canister and then, the gasoline vapor adsorbed in the canister at the time of operating an engine, is introduced into a gas-liquid contact cylinder and is brought into contact with a liquid gasoline therein so as to absorb the gasoline vapor to the liquid gasoline.

According to the above-described conventional method, since properties of the liquid gasoline which the gasoline vapor is brought into contact with are the same as those of the liquid gasoline within the fuel tank, absorptivity of the gasoline vapor to the liquid gasoline is not sufficient. Therefore, there are problems that the amount of the gasoline vapor which is not absorbed to the liquid gasoline and is introduced into a canister is increased and that the canister is needed to have a large size and the amount of the gasoline vapor to be treated in an engine is increased.

### SUMMARY OF THE INVENTION

Accordingly, the object of the present invention is to provide a method for treating gasoline vapor and an apparatus therefor, in which gasoline vapor generated from a fuel tank is brought into contact with a liquid gasoline to make the latter absorb the former, wherein the absorptivity of the gasoline vapor is elevated and the above-described problems are solved.

In order to solve the above-described problems, according to a first aspect of the present invention, there is provided a method for treating gasoline vapor, comprising the steps of:

separating a liquid gasoline within a fuel tank into a low boiling point component and a high boiling point component;

introducing an extractive gasoline composed of the high boiling point component into gas-liquid contact means;

introducing gasoline vapor within the fuel tank into the gas-liquid contact means;

bringing the gasoline vapor into contact with the extractive gasoline composed of the high boiling point component via the gas-liquid contact means to make the extractive gasoline absorb a part of the gasoline vapor; and

introducing a residual of the gasoline vapor not absorbed by the extractive gasoline into a canister.

In this first aspect, a step of cooling the extractive gasoline within the gas-liquid contact means may be further provided.

According to a second aspect of the present invention, there is provided an apparatus for treating gasoline vapor, which is for use in the first aspect, and which comprises separation means of introducing a liquid gasoline within a fuel tank and separating it into a low boiling point component and a high boiling point component, and gas-liquid contact means of bringing gasoline vapor within the fuel tank into contact with an extractive gasoline composed of the high boiling point component separated by the separation means,

wherein the gasoline vapor is contacted with the extractive gasoline so as to absorb a part of the former to the latter, and a residual of the gasoline vapor not absorbed by the extractive gasoline is introduced into a canister.

In this second aspect, a cooler may also be provided in the gas-liquid contact means.

### BRIEF DESCRIPTION OF THE DRAWINGS

FIG. 1 is a schematic view showing one embodiment of a treatment apparatus of gasoline vapor according to the present invention.

FIG. 2 is a characteristic view showing absorptivity of the gasoline vapor of Experiment 1 in the present invention.

FIG. 3 is a characteristic view showing absorptivity of the gasoline vapor of Experiment 2 in the present invention.

FIG. 4 is a characteristic view showing absorptivity of the gasoline vapor of Experiment 3 in the present invention.

### EMBODIMENT

A preferred embodiment according to the present invention is described by referring to an example shown in accompanying drawings.

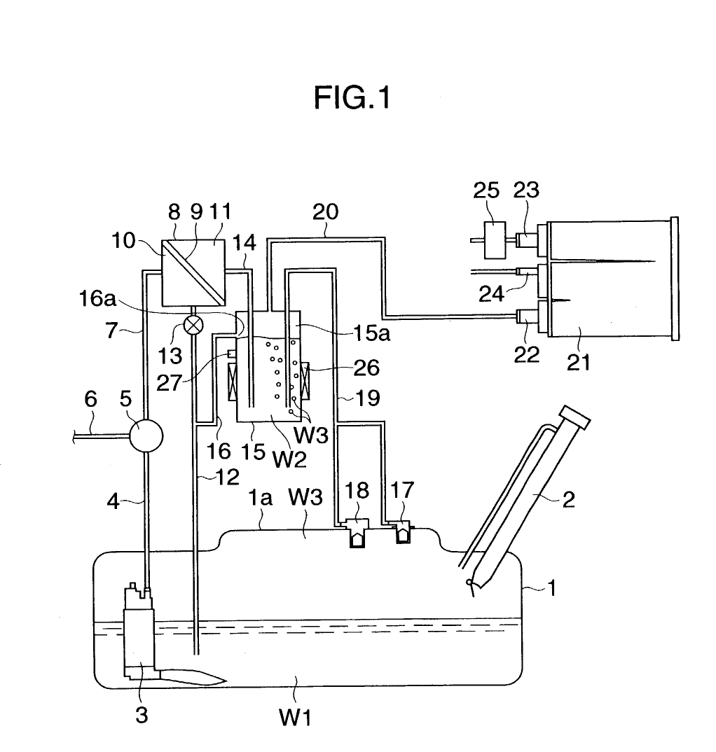

FIG. 1 is a schematic view showing one embodiment of a treatment apparatus of gasoline vapor according to the present invention. In this FIG. 1, a fuel tank 1 is loaded on a motor vehicle, and in the fuel tank 1, a liquid gasoline W1 is reserved. On the fuel tank 1, an oil feed cylinder 2 is provided and moreover, within the fuel tank 1, an electric fuel pump 3 operating at the time of driving an engine is disposed.

The electric fuel pump 3 feeds the liquid gasoline W1 within the fuel tank 1 to an engine side passage 6 through a fuel feed passage 4 and a pressure regulator 5. The pressure regulator 5 feeds, to a first feed passage 7, the excess liquid gasoline not fed to the engine side passage 6, in the liquid gasoline W1 fed from the electric fuel pump 3 at the time of driving the engine. The other end of the first feed passage 7 is communicated with separation means 8.

The separation means 8 is divided into a low boiling point component chamber 10 and a high boiling point component chamber 11 by means of a separation membrane 9. As the separation membrane 9 is used a membrane of permeating the high boiling point component and not permeating the low boiling point component in the liquid gasoline W1, such as a membrane of preferentially permeating an aromatic component, for example, a polyvinyl alcohol film. The separation means 8 may also be constructed so as to take out the separated high boiling point component to a second feed passage 14 described later, by using a zeolite-type separation membrane of permeating the low boiling point component in the liquid gasoline W1.

The first feed passage 7 is communicated with the low boiling point component chamber 10 of the separation means 8. A main return passage 12 is opened and communicated with the low boiling point component chamber 10 at one end and, at the other end, the main return passage 12 is opened and communicated with a periphery of a bottom part of the fuel tank 1. An adjustable valve 13 is provided on the main return passage 12.

The second feed passage 14 is opened and communicated with the high boiling point component chamber 11 of the separation means 8 at one end and, at the other end, the second feed passage 14 is opened and communicated with the inside of the gas-liquid contact means 15. In the embodiment, as the gas-liquid contact means 15 is used a gas-liquid contact cylinder comprising a bubble cylinder where a predetermined amount of the liquid is stayed and within the liquid, a gas is introduced to thereby come into contact with the liquid. In this embodiment, the gas-liquid contact means is described below as a gas-liquid contact cylinder 15.

An auxiliary return passage 16 is opened and communicated with the upper side surface of the gas-liquid contact cylinder 15 at one end, and the other end of the auxiliary return passage 16 comes down to communicate with the main return passage 12. An open part 16a of the auxiliary return passage 16 to the gas-liquid contact cylinder 15 is positioned such that when a predetermined amount of the liquid is stayed within the gas-liquid contact cylinder 15 and more liquid is introduced within the gas-liquid contact cylinder 15, the excess liquid flows out through the auxiliary return passage 16. Further, the open part 16a of the auxiliary return passage 16 is positioned such that a gas chamber 15a having a predetermined volume is formed above the top surface of the liquid stayed in the predetermined amount.

A fuel cutoff valve 17 and a fill-up regulating valve 18 closing in the case of filling up the tank at the refueling are provided on an upper wall 1a of the fuel tank 1. A first evaporated fuel passage 19 is communicated with the fuel cutoff valve 17 and the fill-up regulating valve 18 at one ends, and at the other end, the first evaporated fuel passage 19 is opened and communicated with the periphery of the bottom part within the gas-liquid contact cylinder 15, so that gasoline vapor W3 within the fuel tank 1 flowing out from the fuel cutoff valve 17 and the fill-up regulating valve 18 is introduced into the periphery of the bottom part of the gas-liquid contact cylinder 15, specifically, into the bottom part of a liquid layer stayed within the gas-liquid contact cylinder 15, through the first evaporated fuel passage 19.

A second evaporated fuel passage 20 is opened and communicated with the gas chamber 15a of the gas-liquid contact cylinder 15 at one end and at the other end, the second evaporated fuel passage 20 is communicated with a tank port 22 of a canister 21. The canister 21 is a known canister prepared by filling in the inside thereof an adsorbent such as an activated carbon or the like, and has a structure such that an atmosphere port 23 is opened at one end, gasoline vapor from the tank port 22 is introduced thereinto and collected on the adsorbent during the stopping of an engine, and at the time of driving the engine, the gasoline vapor adsorbed and collected is discharged from a purge port 24 to an inlet pipe of the engine by a negative pressure in the inlet pipe. The numeral 25 indicates a canister closed valve (CCV).

An operation of the embodiment is described below.

When the electric fuel pump 3 is operated at the time of driving the engine, the liquid gasoline W1 within the fuel tank 1 is fed to the engine (not shown) through the pressure regulator 5 from the engine side passage 6. At this time, the excess fluid (gasoline W1) not fed to the engine side passage 6 is fed within the low boiling point component chamber 10 of the separation means 8 through the first feed passage 7 from the pressure regulator 5. Then, the low boiling point component chamber 10 has a higher pressure than the high boiling point component chamber 11, whereby the fed liquid gasoline W1 is passed through the separation membrane 9, separated into the low boiling point component and the high boiling point component by the separation membrane 9, and the high boiling point component is extracted to the high boiling point component chamber 11. The thus-extracted fluid gasoline (hereinafter referred to as extractive gasoline) W2 containing a large amount of the high boiling point components is introduced within the gas-liquid contact cylinder 15 through the second feed passage 14.

After the extractive gasoline W2 introduced within the gas-liquid contact cylinder 15 is collected within the gas-liquid contact cylinder 15 and a level thereof reaches the position of the open part 16a on the auxiliary return passage 16, namely, a predetermined amount of the gasoline is collected, the introduced extractive gasoline W2 over the predetermined amount is flowed out from the open part 16a to the auxiliary return passage 16 so as to replace an old portion of the extractive gasoline W2 introduced in the gas-liquid contact cylinder 15 with a new portion thereof and furthermore returned within the fuel tank 1 through the main return passage 12.

Examples of the method for collecting the predetermined amount of the extractive gasoline W2 within the gas-liquid contact cylinder 15 as described above include a method where when the extractive gasoline W2 is introduced as described above during the driving of a motor vehicle and the motor vehicle is stopped for the refueling, the predetermined amount of the extractive gasoline W2 is collected within the gas liquid contact cylinder 15, or a method where the electric fuel pump 3 is operated at the refueling, the liquid gasoline W1 is continuously fed and the replacement of the extractive gasoline W2 is performed while keeping the predetermined amount of the extractive gasoline W2 within the gas-liquid contact cylinder 15.

As described above, when refueling to the fuel tank 1 is performed in the state where the predetermined amount of the extractive gasoline W2 is stayed within the gas-liquid contact cylinder 15, the gasoline vapor W3 generated within the fuel tank 1 at the refueling is introduced to the bottom part of the gas-liquid contact cylinder 15, specifically, the bottom part of the extractive gasoline W2 layer through the first evaporated fuel passage 19 from the fuel cutoff valve 17 and the fill-up regulating valve 18. This gasoline vapor W3 introduced is contacted with the fluid extractive gasoline W2 and a part of the fuel components in the gasoline vapor W3 is liquefied and absorbed to the fluid extractive gasoline W2. At this time, the extractive gasoline W2 contains a large amount of high boiling point components as compared with the liquid gasoline W1 before the extraction, and therefore, the absorptivity of the gasoline vapor W3 to the extractive gasoline is elevated as compared with the case where the gasoline vapor W3 is contacted with the liquid gasoline W1 before the extraction. As the amount of the extractive gasoline W2 stayed is larger, the absorptivity is more increased.

Then, the gasoline vapor not absorbed comes up within the gas chamber 15a, is introduced into the inside of the canister 21 from the tank port 22 of the canister 21 through the second evaporated fuel passage 20, and is adsorbed and collected on the adsorbent.

As shown in FIG. 1, a cooler 26 and a temperature sensor 27 are provided on the gas-liquid contact cylinder 15 and the temperature within the gas-liquid contact cylinder 15, specifically, the temperature of the extractive gasoline W2 is lowered by the cooler 26, whereby the absorptivity may also be increased. In the case of providing the cooler 26 as such, the gas-liquid contact cylinder 15 is coated with a thermal insulating material to increase cooling efficiency.

Simulation experiment results are described with respect to the absorptivity of the gasoline vapor generated at the refueling into the fuel tank 1. Hereinafter “litter” is expressed by L.

The refueling conditions (ORVR (Onboard Refueling Vapor Recovery) test conditions prescribed by Environmental Protection Agency) were set such that the remaining liquid gasoline temperature within the tank was 26.7° C., the refueling gasoline temperature was 19.4° C. and the gasoline refueling rate was 37.9 L/min.

(Experiment 1)

Conditions

(1) Temperature within the gas-liquid contact cylinder: 26.7° C.

(2) Pressure within the gas-liquid contact cylinder: 0 atm

(3) Inflow gasoline vapor volume within the gas-liquid contact cylinder: 100 L

(4) Extractive gasoline volume within the gas-liquid contact cylinder: from 0 to 2 L

(5) Gasoline vapor concentration: 34.6 mol % (corresponding to the concentration at the refueling)

(6) RVP of the liquid gasoline within the fuel tank: 0.62 atm

(7) RVP of the extractive gasoline: from 0.05 to 0.62 atm

RVP is an abbreviated name of Reid Vapor Pressure, and indicates a vapor pressure at 37.8° C. As the RVP is lower, the amount of the high boiling point component is larger in the extractive gasoline.

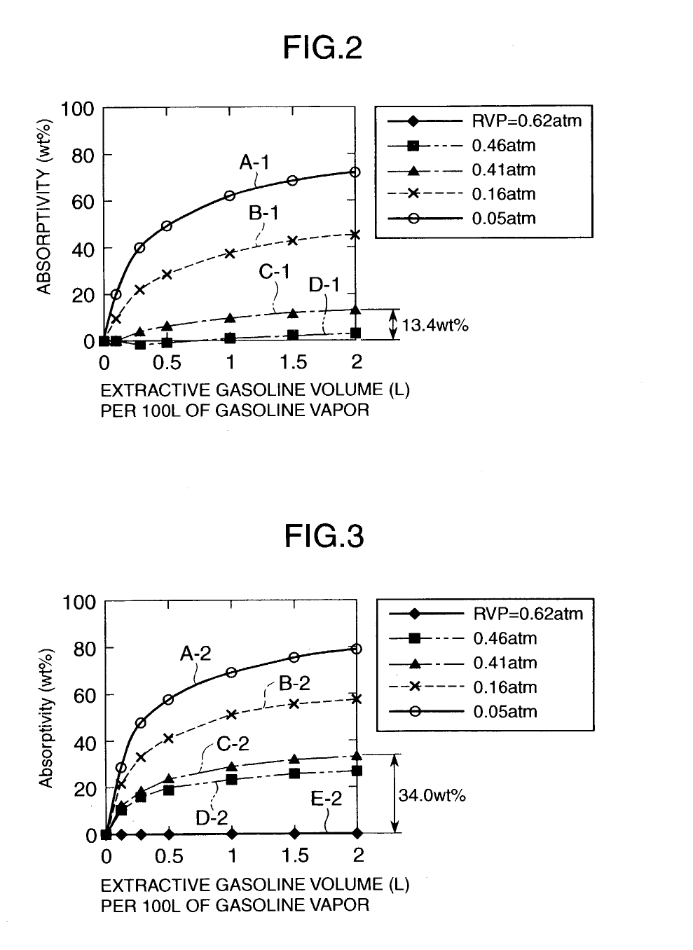

In this Experiment 1, the absorptivity of the gasoline vapor in the case where the volume of the extractive gasoline per 100 L of the gasoline vapor is from 0 to 2 L is shown in FIG. 2.

As shown in this FIG. 2, in the case where the RVP of the extractive gasoline was 0.05 atm, the absorptivity of the gasoline vapor per from 0 to 2 L of the extractive gasoline exhibited the value of property A-1 and when the extractive gasoline was 2 L, the absorptivity exhibited the value of 70 wt %. As a result, approximately 30% of the remaining gasoline vapor not absorbed was introduced into and adsorbed to the canister 21, whereby downsizing of the canister 21 and reduction in the amount of the gasoline vapor treated in the engine can be attained.

In the case where the RVP of the extractive gasoline was 0.16 atm, the absorptivity of the gasoline vapor per from 0 to 2 L of the extractive gasoline exhibited the value of property B-1 and when the extractive gasoline was 2 L, the absorptivity exhibited the value of approximately 50 wt %.

In the case where the RVPs of the extractive gasoline were 0.41 atm and 0.46 atm, the absorptivity in each case exhibited the values of properties C-1 and D-1, respectively. In the case where the RVP was 0.62 atm, the absorptivity of the gasoline vapor was not shown.

(Experiment 2)

Conditions

(1) Temperature within the gas-liquid contact cylinder: 20° C.

The other conditions are the same as the conditions (2) to (7) in the Experiment 1.

In this Experiment 2, the absorptivity of the gasoline vapor in the case where the volume of the extractive gasoline per 100 L of the gasoline vapor is from 0 to 2 L is shown in FIG. 3.

As shown in this FIG. 3, in the case where the RVP of the extractive gasoline was 0.05 atm, the absorptivity of the gasoline vapor per from 0 to 2 L of the extractive gasoline exhibited the value of property A-2 and when the extractive gasoline was 2 L, the absorptivity exhibited the volume of approximately 80 wt %.

In the case where the RVPs of the extractive gasoline were 0.16 atm, 0.41 atm, 0.46 atm and 0.62 atm, the absorptivity in each case exhibited the values of properties B-2, C-2, D-2 and E-2, respectively.

(Experiment 3)

Conditions

(1) Temperature within the gas-liquid contact cylinder: 0° C.

The other conditions are the same as the conditions (2) to (7) in the Experiment 1.

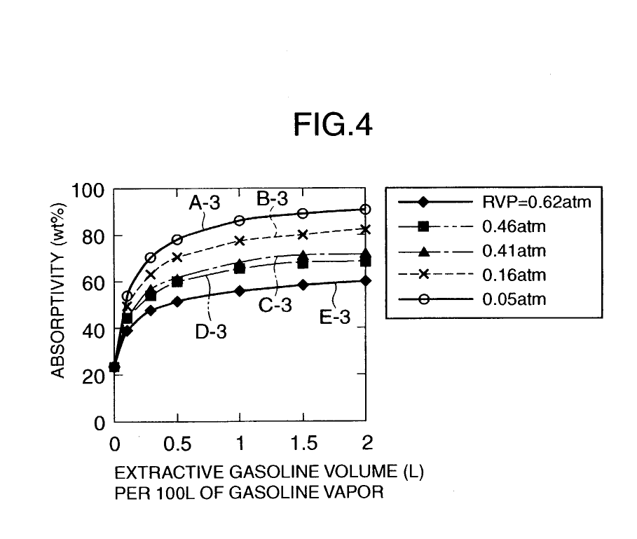

In this Experiment 3, the absorptivity of the gasoline vapor in the case where the volume of the extractive gasoline per 100 L of the gasoline vapor is from 0 to 2 L is shown in FIG. 4.

As shown in this FIG. 4, in the case where the RVP of the extractive gasoline was 0.05 atm, the absorptivity of the gasoline vapor per from 0 to 2 L of the extractive gasoline exhibited the value of property A-3 and when the extractive gasoline was 2 L, the absorptivity exhibited the volume of approximately 90 wt %.

In the case where the RVPs of the extractive gasoline were 0.16 atm, 0.41 atm, 0.46 atm and 0.62 atm, the absorptivity in each case exhibited the values of properties B-3, C-3, D-3 and E-3, respectively.

As is apparent from the Experiments above, as the amount of the high boiling point component in the extractive gasoline W2 is larger, or the amount of the extractive gasoline is larger, furthermore the temperature within the gas-liquid contact cylinder is lower, the absorptivity of the gasoline vapor to the extractive gasoline is higher.

In the above embodiment, the separation membrane 9 composed of a polyvinyl alcohol film is used as the separation means 8, however, other separation membranes or separation means which can separate a gasoline component into a low boiling point component and a high boiling point component may also be used.

Furthermore, in the embodiment, the bubble cylinder is used as the gas-liquid contact means 15, however, in addition to this bubble cylinder, a known absorption tower may also be used, such as a packed tower where a liquid and a gas are injected into fillers and contacted with each other within the fillers, a spray tower where a liquid is formed into fine droplets and the droplets are sprayed in a gas to come into contact with the gas, or a wetted wall tower where a liquid is flowed down in a form of a thin film along an inner wall of a vertical tube and contacted with a gas flowing through the center part of the tube.

Further, the gas-liquid contact means 15 may also be disposed within the fuel tank 1.

As described in the foregoing pages, according to the present invention, gasoline vapor from a fuel tank is brought into contacted with an extractive gasoline containing a large amount of high boiling point components extracted from a liquid gasoline, so that the absorptivity of the gasoline vapor to the extractive gasoline is increased as compared with the one obtained by contacting gasoline vapor with a liquid gasoline having the same component as a liquid gasoline within a fuel tank according to the above-described conventional method. Therefore, the amount of the gasoline vapor which is not absorbed to the extractive gasoline and introduced into a canister is reduced, as a result, downsizing of a canister and reduction in the amount of the gasoline vapor treated in an engine can be attained.

Furthermore, the extractive gasoline is cooled by cooling the gas liquid contact means, whereby the absorptivity of the gasoline vapor to the extractive gasoline can be still further increased and the above-described effect can be more improved.

What is claimed is:

1. A method for treating gasoline vapor, comprising the steps of:
separating a liquid gasoline within a fuel tank into a low boiling point component and a high boiling point component;
introducing an extractive gasoline composed of the high boiling point component into gas-liquid contact means;
introducing gasoline vapor within the fuel tank into said gas-liquid contact means;
bringing said gasoline vapor into contact with the extractive gasoline composed of said high boiling point component by the gas-liquid contact means to make the extractive gasoline absorb a part of the gasoline vapor; and
introducing the gasoline vapor not absorbed to the extractive gasoline into a canister.

2. The method for treating gasoline vapor as claimed in claim 1, further comprising a step of cooling said extractive gasoline within said gas-liquid contact means.

3. An apparatus for treating gasoline vapor, comprising separation means of introducing a liquid gasoline within a fuel tank and separating it into a low boiling point component and a high boiling point component, and gas-liquid contact means of bringing gasoline vapor within the fuel tank into contact with an extractive gasoline composed of the high boiling point component separated by said separation means, wherein a part of the gasoline vapor is absorbed to the extractive gasoline by contacting said gasoline vapor with said extractive gasoline, and the gasoline vapor not absorbed to the extractive gasoline is introduced into a canister.

4. The apparatus for treating gasoline vapor claimed in claim 3, further comprising a cooler on said gas-liquid contact means.
